(19) United States
(12) Patent Application Publication
(10) Pub. No.: US 2005/0151992 A1
(43) Pub. Date: Jul. 14, 2005

(54) Document processing system providing enhanced copy project retention features and related methods

(75) Inventors: Geoffrey Howard Shaw, Webster, NY (US); Michael Charles Kabot, Penfield, NY (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Pharos Systems International, Inc., East Rochester, NY (US)

(21) Appl. No.: 11/034,572

(22) Filed: Jan. 13, 2005

Related U.S. Application Data
(60) Provisional application No. 60/536,145, filed on Jan. 13, 2004.

(51) Int. Cl. G06F 3/12; G06F 7/04; G06F 11/30; G06K 19/00; H04L 9/32

(52) U.S. Cl. 358/1.14; 358/1.15; 340/5.2; 713/200

(57) ABSTRACT

A document processing system may include a document scanner for collecting document image data for a given copy project for a given user, a document printer, and a controller. The controller may cooperate with the document scanner to retain document image data for the given copy project if a printing cost therefor is greater than a copy account value for the given user. The controller may thereafter cooperate with the document printer to print the retained document image data for the given copy project based upon an increase in the copy account value to at least equal the printing cost.

### CROSS-REFERENCE TO RELATED APPLICATIONS

This application claims the benefit of U.S. Provisional Application No. 60/536,145, filed Jan. 13, 2004, which is hereby incorporated herein in its entirety by reference.

### FIELD OF THE INVENTION

The present invention relates to the field of document processing and reproduction systems, and, more particularly, to document imaging and printing systems and related methods.

### BACKGROUND OF THE INVENTION

A multi-function device (MFD) is a device that provides multiple functions, such as a copier that also provides printing capabilities. The present invention is particularly applicable to copy/print control and cost accounting systems that track usage of MFDs so that the appropriate user or client accounts can be charged accordingly, although it may be used for other applications as well, as will be understood by those skilled in the art.

Two markets in which copy/print accounting systems are frequently used are the educational (e.g., universities) and public library markets, which are sometimes referred to as “pay-for-print/copy markets.” In these markets, one key requirement is to provide a fully automated system to collect for payment of print and copy usage to recoup the costs of ink, paper, machine maintenance and acquisition, etc. Collection of payment may be performed, for example, through (1) an online account with a network username/password, (2) using a card or token as a system identification, or (3) by paying with money at the copier or MFD (e.g., using a magnetic stripe card with a monetary amount assigned to the card itself, bills, and/or coins).

In the past, printers and copiers have been separate physical devices, and the technology for addressing them has been very different. Accordingly, present cost accounting approaches for MFDs and the technology that enables them typically deal with print and copy functions separately.

A typical prior art use case for making copies in a pay-for-print/copy environment may be as follows. A user walks up to a copier or MFD to perform a copy job. The MFD is at first locked and unavailable for use. A release station is located next to MFD and connected thereto. The release station may take many forms (e.g., computer, network terminal, keypad, token reader, etc.), but whatever the form it serves the same purpose of enabling the MFD for copying by the user.

The user identifies himself at the release station using the appropriate network username/password, card ID, or by providing money to the release station (i.e., magnetic card with monetary amount recorded thereon, bills, and/or coins). The release station retrieves the user's available balance (e.g., $2.00) and the applicable cost per copy (e.g., $0.10), which is typically set by a system administrator or attendant. If the user has a sufficient balance to make at least one copy, the release station unlocks the MFD and makes it available for copying.

If the user is not paying attention to the balance in his account, or how many pages are in the copy job, he may put a hardcopy document in the MFD document feeder which his account has insufficient funds to cover. For purposes of the present example, it will be assumed that the document to be copied is thirty (30) pages in length. The user places the document in the copier's feeder, programs the copy options, and hits the start button to start the copy job. As each page of the document is copied, a hardware pulse is generated that the release station recognizes. The release station debits the user's account balance for each page ($0.10 in the present case).

When the account balance reaches $0.00 (i.e., after 20 pages have been copied), the release station locks the copier from use and interrupts the copy job mid-course. The user is then left with part of the copy job completed (20 pages), and part uncompleted (10 pages). The user then has to go add more money (at least $1.00 in this case) to his account before continuing.

The above-described prior art page-by-page technology was originally created for analog copiers and migrated into digital MFDs by default. The downside of this technology is that if the user runs out of money, he only gets part of his copy job completed. He then has to add more money to his account and come back to the MFD with the document originals and figure out where the copy stopped so he does not pay for pages already copied. This approach can also slow down the copying speed of a device, given that the hardware pulses have to be provided and read for every page.

One example of a pay-for-print/copy system is disclosed in U.S. Pat. No. 6,712,266 to Bartley et al. This patent discloses a networked copier and printer system including a network transaction station that accepts a customer ID from a magnetic card or bar code reader, or from a keypad input. After the customer enters his or her PIN, the account balance is downloaded from a central network database, and the copier or printer is enabled. An add-value station on the network allows the customer to deposit cash and add to his or her account balance, after entering a customer ID and PIN. When the PIN is verified, the account balance is downloaded and displayed at the transaction station, and copying is enabled if the account balance is higher than a minimum level. The system also allows users to send print jobs to a central print queue, and similarly print the print jobs at a specified printer location via a network transaction station at the location.

Despite the features provided by such systems, additional copy job retention and control features may be desirable in certain applications.

### SUMMARY OF THE INVENTION

In view of the foregoing background, it is therefore an object of the present invention to provide a document processing system providing enhanced copy job retention features and related methods.

This and other objects, features, and advantages in accordance with the present invention are provided by a document processing system in which document image data for a given copy project or job for a given user may be retained for later printing if a printing cost therefor is greater than a copy account value for the given user. More particularly, the system may include a document scanner for collecting document image data for the given copy project, a document printer, and a controller. The controller may cooperate with the document scanner to retain document image data for the given copy project, e.g., in a print later queue, if a printing cost therefor is greater than a copy account value for the given user. The controller may thereafter cooperate with the document printer to print the retained document image data for the given copy project based upon an increase in the copy account value to at least equal the printing cost.

Accordingly, if a user begins copying a document but has insufficient funds in his account to cover the printing cost of the entire document, the entire document may still be scanned and the document image data therefor retained for later printing. As such, the user will not have to keep track of what was copied and what was not. Moreover, in the case of shared or public documents, such as in a library, the user may return the document to circulation quicker since he does not have to keep the document until his copy account value is increased.

In addition, the controller may cooperate with the document scanner and document printer to print the collected image data if the copy account value is at least equal to the printing cost. That is, the collected image data may be printed directly without being retained for later printing. The document processing system may further include a local area network (LAN) connecting the controller to the document scanner and the document printer. Moreover, a user access device (e.g., a computer) may be connected to the LAN for causing the controller to cooperate with the document printer to print the retained document image data for the given copy job.

In accordance with another advantageous aspect of the invention, the copy account for the given user may have a security level associated therewith. As such, the controller may prohibit printing of the retained document image data for the given copy job if the security level is below a security threshold. Thus, for example, where the document scanner and/or document printer are located in a secure environment, a user with a relatively low level security clearance (e.g., an assistant) may be able to scan a document for someone with a higher level security clearance (e.g., a manager), but only the person with the higher level security clearance will ultimately be allowed to print the document.

In certain embodiments, the controller may comprise a payment input device, such as a card/token reader or currency input device, and the copy account value may be based upon an amount of payment received by the payment input device (e.g., the value stored on the card, the amount of currency input, etc.). Furthermore, a housing may be included for carrying the document scanner and document printer, i.e., when the document scanner and document printer are in a single copy machine or MFD.

The document processing system may further include a display for cooperating with the controller to display instructions for printing the retained document image data after the copy account value is increased to at least equal the printing cost. Similarly, the controller may cooperate with the document printer to print an instruction sheet including instructions for printing the retained document image data after the copy account value is increased to at least equal the printing cost. The controller may also decrease the copy account value by the printing cost upon printing the retained document image data.

A document processing method aspect of the invention may include collecting document image data for a given copy project for a given user. Furthermore, document image data for the given copy project may be retained if a printing cost therefor is greater than a copy account value for the given user, and the retained document image data may thereafter be printed based upon an increase in the copy account value to at least equal the printing cost.

### BRIEF DESCRIPTION OF THE DRAWINGS

FIG. 1 is a schematic block diagram of a document processing system in accordance with the present invention.

FIG. 2 is schematic block diagram of a network-based embodiment of the document processing system of FIG. 1.

FIGS. 3 and 4 are flow diagrams illustrating document processing methods in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

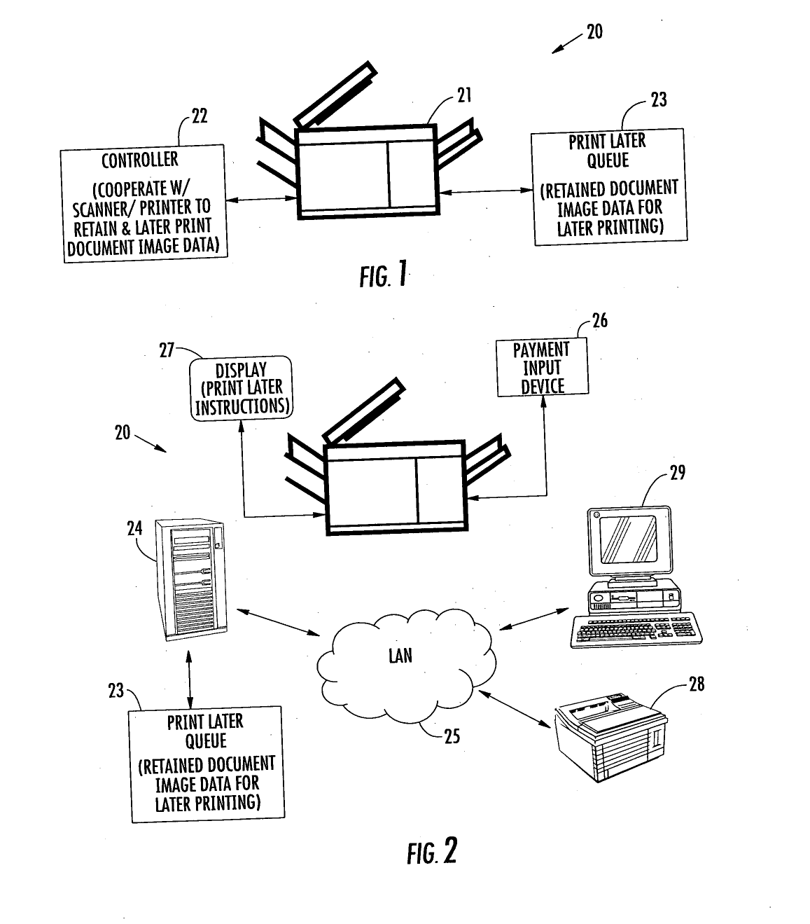

Referring initially to FIG. 1, a document processing system 20 in accordance with the invention is first described. The system 20 illustratively includes a copier or MFD 21 including a document scanner for collecting document image data for a given copy project or job for a given user, and a document printer. As will be discussed further below, the document scanner and document printer need not be included in the same housing (i.e., the same copier or MFD) in all embodiments, and may instead be stand alone devices at different locations.

The system 20 further illustratively includes a controller 22 which cooperates with the document scanner to retain document image data for the given copy project, e.g., in a print later queue 23, if a printing cost therefor is greater than a copy account value or balance for the given user. The controller 22 may take various forms in different embodiments, and certain functions or operations of the controller may be distributed across different devices, as will be discussed further below. The controller 22 thereafter cooperates with the document printer to print the retained document image data for the given copy project based upon an increase in the copy account value to at least equal the printing cost. That is, the controller 22 cooperates with the document printer to print the retained document image data once the user has increased the copy account value to equal or exceed the printing cost.

Accordingly, if a user begins copying a document but has insufficient funds in his account to cover the printing cost of the entire document, the entire document may still be scanned and the document image data therefor retained for later printing. As such, the user will not have to keep track of what was copied and what was not. Moreover, in the case of shared or public documents, such as in a library, the user may immediately return the document to circulation since he does not have to keep the document until he has an opportunity to increase his copy account value.

Of course, in the case where the copy account value is at least equal to the printing cost for the given document, the controller 22 may cooperate with the document scanner and document printer to print the collected image data. That is, the collected image data may be printed directly without being retained in the print later queue 23 for later printing.

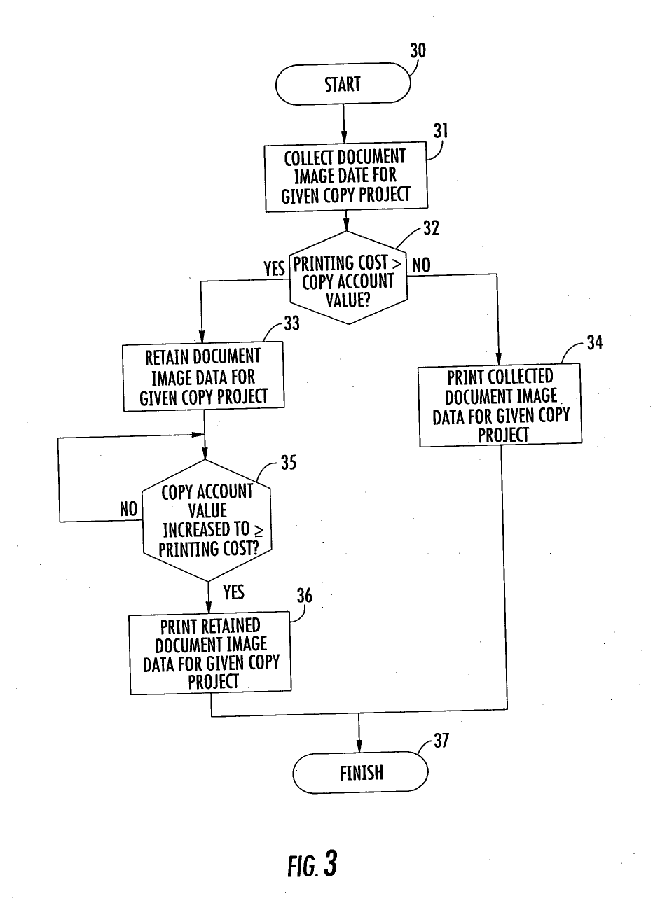

Turning now additionally to FIG. 2, an implementation of the document processing system 20 in a network environment will now be described. In the illustrated embodiment, at least some of the functions of the controller 22 are performed by a computer server 24, which is connected with the copier/MFD 21 via a local area network (LAN) 25. It should be noted that the LAN 25 connections may be hardwired connections and/or wireless connections, as in the case of a wireless LAN, as will be appreciated by those skilled in the art.

In an environment such as a university, for example, the server 24 may maintain a database with copy account information for multiple users. This allows users to make copies at any number of copiers/MFDs connected to the LAN 25 simply by providing an account identifier at a payment input device 26 (i.e., a release station) located adjacent the copier/MFD. The given copier/MFD and the server 23 cooperate to validate the user's account, and the copier/MFD is generally enabled for scanning so long as the copy account value for the given user is at least equal to a copy threshold, which may be the printing cost for printing a single page, for example.

The payment input device 26 may include a keypad for typing in an account number, or it may have a token or card reader (e.g., a magnetic card reader) for reading account information from a token/card assigned to the user, for example, as will be appreciated by those skilled in the art. In some embodiments, the payment input device 26 may also accept currency so that users can walk up and establish a temporary cash account with a copy account value equal to the amount of money that is input.

The server 24 may also maintain the print later queue 23 in addition to the copy account value information. More particularly, retained document image data from numerous document scanners connected to the LAN 25 may be stored in the centralized print later queue 23 for later printing. The retained document image data for each document may be saved as respective electronic files (i.e., print job files) which are assigned unique network file names for ready access at a later time. Of course, in some embodiments, such as when the copier/MFD is a “stand-alone” device not connected to a network, it may maintain its own local print later queue 23. As such, it will be appreciated that in different embodiments, the various functions of the controller 22 may be performed by the control circuitry of the copier/MFD 21, the input device 26, and/or the server 24, for example.

When the printing cost for the number of pages scanned by the copier/MFD 21 exceeds the copy account value for a given user, the document image data for the given document is retained in the print later queue 23. By way of example, the copier/MFD 21 may combine the individual images for each scanned page of a document and combine them into a single document image data file, which is then forwarded to the server 24 in the case of a centralized print later queue 23, or stored locally if the queue is local to the copier/MFD. When this occurs, the copier/MFD 21 may advantageously notify the user via an attached display 27, and/or by printing an instruction sheet. The display 27 and/or instruction sheet may provide the user with instructions on how to increase his copy account balance, and for printing the retained document image data once the account balance has been increased to at least equal the printing cost.

Numerous approaches may be used for increasing the copy account value. For example, this may be done at designated vending machines, at a customer assistance center, or by electronic payment (e.g., bank or credit card, etc.). In the case where the user has established a temporary cash account, this may be done by inputting more currency in the input device 26.

Once the copy account value is increased to at least equal the printing cost of the given document, the user may proceed to print the document in various ways. In the case of a stand alone copier/MFD 21, this may be done by simply re-entering the user's account identifier at the input device 26, or entering a code provided with the instructions for identifying the retained document image data file to be printed (e.g., in the case of a temporary cash account). Once the increased account value is verified by the copier/MFD 21, input device 26, and/or server 24, the retained document image data for the given document is printed, and the copy account value is decreased by the printing cost. This operation may be performed by the server 24 in the case of centralized copy accounts, or locally by the input device 26 in the case of a copy card or temporary cash account, for example.

Of course, in the illustrated network embodiment, a user may advantageously print the retained document image data at other printers 28 connected to the LAN 25. By way of example, a user access device, such as a computer 29, may be connected to the LAN 25 for causing the server 24 to cooperate with the document printer of the copier/MFD 21, or the printer 28, to print the retained document image data for the given copy job. More particularly, the computer 29 may be in a computer cluster connected to the LAN 25, and the printer 25 may be a nearby cluster printer, for example.

In accordance with another advantageous aspect of the invention, the copy account for the given user may have a security level associated therewith. As such, the controller 22 may prohibit printing of the retained document image data for the given copy job if the security level is below a security threshold.

This option is particularly advantageous where confidential or otherwise secure documents are to be copied, and it gives a system administrator control over who gets to view documents reproduced at a particular copier. More particularly, the system 20 may record when documents are scanned and when they are printed, and it may control who may do so. For instance, an attendant may be allowed to copy a sensitive document, but not print it, while others within the organization with authorized access may do so. The system 20 may record when, where and who scanned these copies (and printing thereof as well).

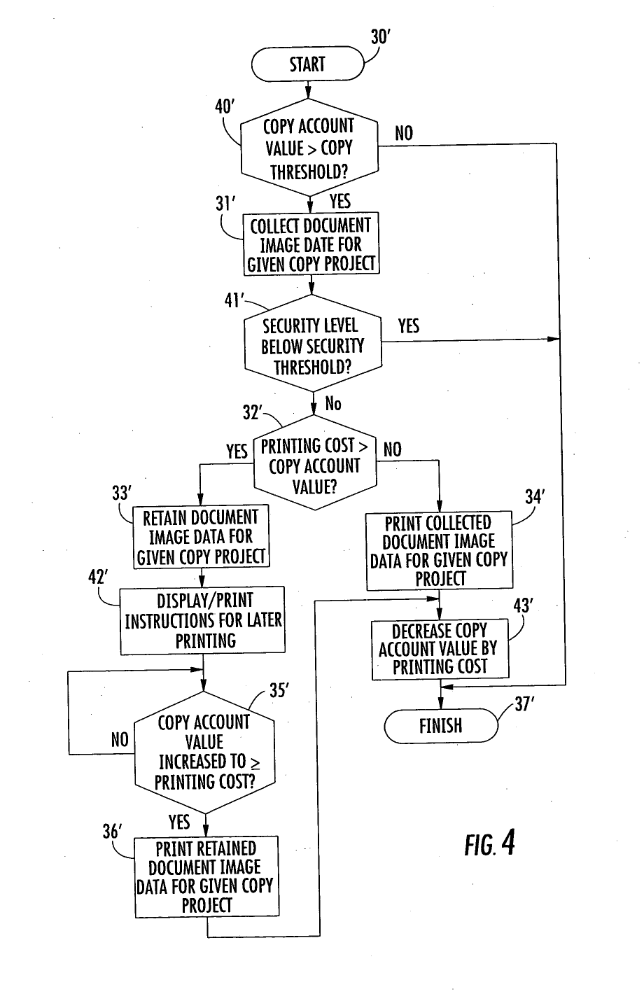

A document processing method aspect of the invention is now described with reference to FIG. 3. Beginning at Block 30, the method illustratively includes collecting document image data for a given copy project for a given user, at Block 31. Document image data for the given copy project is retained if a printing cost therefor is greater than a copy account value for the given user, at Blocks 32-33. Otherwise, the collected document image data may be printed, at Block 34. The retained document image data may thereafter be printed based upon an increase in the copy account value to at least equal the printing cost, at Blocks 35-36, as discussed further above, thus concluding the illustrated method (Block 37).

Additional method aspects of the invention are now described with reference to FIG. 4. Initially, the controller 22 may first cooperate with the copier/MFD 21 to enable scanning of a given document if the copy account value at least equals a copy threshold, as discussed above (Block 40′). Moreover, after the document image data is collected (Block 31′), printing of the document image data may be prohibited if the security level associated with the given user's copy account is below a security threshold, at Block 41′, as also discussed above. Additionally, the method may further include printing and/or displaying instructions for printing the retained document image data, at Block 42′ as further discussed above. A computer-readable medium having computer-executable instructions for performing the above-described steps is also provided in accordance with the present invention.

The invention will be further understood with reference to the following example thereof.

### EXAMPLE

A user walks up to the copier/MFD 21 to perform a copy project or job. The copier/MFD 21 is locked and unavailable for use. The user identifies himself (or enters currency to establish a temporary cash account) via the input device 26. Based upon the network username/password, card/token ID, or money provided (i.e., magnetic card, bills, or coins), the copier/MFD 21 determines the user's available copy account value or balance (e.g., $2.00) and the printing cost per document page (e.g., $0.10). The copier/MFD 21 is enabled for scanning if the copy account value is sufficient to make at least one copy. The user then puts a hardcopy document in the copier/MFD 21 document feeder (e.g., 30 pages), programs the desired copy options, and presses the start button to start the copy job.

In accordance with the present invention, the copier/MFD 21 scans all pages of the document and counts the number of pages (30). The copier/MFD 21 recognizes that the user does not have sufficient funds to perform the requested transaction (i.e., printing 30 pages), but nonetheless continues to scan the entire document. As such, the copier/MFD 21 turns the collected document image data for the copy job into a document image data file, i.e., a print job, and forwards the print job to the print later queue 23 with a network username or other identifier of the user or job.

The MFD then displays or prints an instruction sheet letting the user know that there was insufficient funds to copy the document, and providing instructions on how to release the job for printing once the copy account value is increased to at least equal the printing cost. The user may then return the original document to its place of origin, and go add more money to his account. The user then comes back to the copier/MFD 21, releases the print job in accordance with the previously provided instructions, and has the full document printed, including all finishing options (e.g., stapling, duplex, etc.). Again, if the copier/MFD 21 is connected to the LAN 25, the user may also be able to advantageously print the stored job at a different printer 28 as well.

Those skilled in the art will appreciate numerous advantages and benefits of the present invention. For example, users do not find out that they have insufficient funds in their copy accounts for copying an entire job half-way through a copy job when the account has been depleted, but not all of the pages have been printed. Moreover, the copy job is kept as a whole, and finishing options will be performed properly and consistently across an entire copy job.

Additionally, the user does not have to page through a hardcopy document to determine where to start re-copying. Plus, the user may return the original document, since it is not necessary when returning to the copier/MFD to print the stored job, which allows the document to be used by others. Also, the user may “queue up” multiple copy jobs even without sufficient funds in his account, and come back later to pay when it is convenient.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A document processing system comprising:
a document scanner for collecting document image data for a given copy project for a given user;
a document printer; and
a controller cooperating with said document scanner to retain document image data for the given copy project if a printing cost therefor is greater than a copy account value for the given user, and thereafter cooperating with said document printer to print the retained document image data for the given copy project based upon an increase in the copy account value to at least equal the printing cost.

2. The document processing system of claim 1 wherein said controller cooperates with said document scanner and document printer to print the collected image data if the copy account value is at least equal to the printing cost.

3. The document processing system of claim 1 further comprising a local area network (LAN) connecting said controller to said document scanner and said document printer.

4. The document processing system of claim 3 further comprising a user access device connected to said LAN for causing said controller to cooperate with said document printer to print the retained document image data for the given copy job.

5. The document processing system of claim 1 wherein the copy account for the given user has a security level associated therewith; and wherein said controller prohibits printing of the retained document image data for the given copy job if the security level is below a security threshold.

6. The document processing system of claim 1 wherein said controller comprises a payment input device, and wherein the copy account value is based upon an amount of payment received by said payment input device.

7. The document processing system of claim 1 further comprising a housing carrying said document scanner and document printer.

8. The document processing system of claim 1 further comprising a display for cooperating with said controller to display instructions for printing the retained document image data after the copy account value is increased to at least equal the printing cost.

9. The document processing system of claim 1 wherein said controller further cooperates with said document printer to print an instruction sheet including instructions for printing the retained document image data after the copy account value is increased to at least equal the printing cost.

10. The document processing system of claim 1 wherein said controller decreases the copy account value by the printing cost upon printing the retained document image data.

11. A document processing system comprising:
a housing;
a document scanner carried by said housing for collecting document image data for a given copy project for a given user;
a document printer carried by said housing; and
a controller for
cooperating with said document scanner and document printer to print the collected image data if a copy account value for the given user is at least equal to a printing cost for the collected document image data, and
cooperating with said document scanner to retain document image data for the given copy project if the printing cost is greater than the copy account value for the given user, and
thereafter cooperating with said document printer to print the retained document image data for the given copy project based upon an increase in the copy account value to at least equal the printing cost.

12. The document processing system of claim 11 further comprising a local area network (LAN) connecting said controller to said document scanner and said document printer.

13. The document processing system of claim 11 wherein said controller comprises a payment input device, and wherein the copy account value is based upon an amount of payment received by said payment input device.

14. A document processing method comprising:
collecting document image data for a given copy project for a given user; and
retaining document image data for the given copy project if a printing cost therefor is greater than a copy account value for the given user, and thereafter printing the retained document image data based upon an increase in the copy account value to at least equal the printing cost.

15. The method of claim 14 further comprising printing the collected image data if the copy account value is at least equal to the printing cost.

16. The method of claim 14 wherein the copy account for the given user has a security level associated therewith; and further comprising prohibiting printing of the retained document image data for the given copy job if the security level is below a security threshold.

17. The method of claim 14 further comprising displaying instructions on a display for printing the retained document image data after the copy account value is increased to at least equal the printing cost.

18. The method of claim 14 further comprising printing an instruction sheet including instructions for printing the retained document image data after the copy account value is increased to at least equal the printing cost.

19. The method of claim 14 further comprising decreasing the copy account value by the printing cost upon printing the retained document image data.

20. A computer-readable medium having computer-executable instructions for performing steps comprising:
collecting document image data for a given copy project for a given user; and
retaining document image data for the given copy project if a printing cost therefor is greater than a copy account value for the given user, and thereafter printing the retained document image data based upon an increase in the copy account value to at least equal the printing cost.

21. The computer-readable medium of claim 20 having further computer-executable instructions for performing a step of printing the collected image data if the copy account value is at least equal to the printing cost.

22. The computer-readable medium of claim 20 wherein the copy account for the given user has a security level associated therewith; and having further computer-executable instructions for performing a step of prohibiting printing of the retained document image data for the given copy job if the security level is below a security threshold.

23. The computer-readable medium of claim 20 having further computer-executable instructions for performing a step of displaying instructions for printing the retained document image data after the copy account value is increased to at least equal the printing cost on a display.

24. The computer-readable medium of claim 20 having further computer-executable instructions for performing a step of printing an instruction sheet including instructions for printing the retained document image data after the copy account value is increased to at least equal the printing cost.

25. The computer-readable medium of claim 20 having further computer-executable instructions for performing a step of decreasing the copy account value by the printing cost upon printing the retained document image data.
